(19) United States
(12) Patent Application Publication
(10) Pub. No.: US 2007/0074675 A1
(43) Pub. Date: Apr. 5, 2007

(54) Cat scratching device

(75) Inventor: Hua Tu, Changhwa (TW)

Correspondence Address: DARBY & DARBY P.C., P. O. BOX 5257, NEW YORK, NY, 10150-5257, US

(73) Assignee: Taiwan Cable Industrial Company, Ltd., Changhwa (TW)

(21) Appl. No.: 11/542,942

(22) Filed: Oct. 3, 2006

Related U.S. Application Data
(60) Provisional application No. 60/723,366, filed on Oct. 3, 2005.

(51) Int. Cl. A01K 15/02

(52) U.S. Cl. 119/706

(57) ABSTRACT

The present invention provides for a cat scratching device that can be used in two different positions. The cat scratching device can be either laid parallel with a horizontal surface, or self-supported at an angle with respect to a horizontal surface by two plate-like arms. The arms are attached with a pivot and are held in the self-supporting position by holders on the back surface of the base. Thus, the present invention provides for an inexpensive, expandable cat scratching device. Additionally, the scratch resistant material can be easily replaced, further lowering the initial cost of the cat scratching device.

### CROSS-REFERENCE TO RELATED APPLICATIONS

This application claim priority to U.S. patent application Ser. No. 60/723,366 filed on Oct. 3, 2005 and incorporated herein, by reference, in its entirety.

### FIELD OF THE INVENTION

The present invention relates generally to a cat scratching device. In particular, the present invention relates to a cat scratching device capable of expanding from a flat position to an inclined one.

### DESCRIPTION OF RELATED ART

It is well known by those who keep pets, such as cats and kittens, that they often scratch furniture, carpeting, and other fabrics and surfaces in an effort to sharpen and maintain their claws. This behavior can be destructive and often causes damage in the household.

In order to prevent the damage caused by this scratching, it has become a common practice to provide cats with an alternative scratching device. Various scratching devices, such as scratching posts, boards, and toys have been developed.

The object of the present invention is to provide a cat scratching device having a planar scratching surface and an expandable, self-supporting means that allows the device to be laid parallel with a horizontal surface or angled with respect to a horizontal surface. A further object of the present invention is to provide a cat scratching device that does not need to be fastened to a door or wall, is inexpensive, and allows for easy assembly and compact storage.

### BRIEF SUMMARY OF THE INVENTION

The present invention provides a cat scratching device with a planar scratching surface, wherein the device can be used in two different positions. The device comprises a base, with a front and a back side, made of an inexpensive material such as plastic that holds a scratch resistant material, such as corrugated cardboard. The self-supporting means comprises two plate-like legs, each having a top and a bottom end. The first leg is attached at its bottom end to the back side of the base, and at its top end to the second leg. The top end of the second leg can be secured to the back of the base, causing the two legs to form roughly a ninety degree angle. The base is thusly supported in an inclined position.

### BRIEF DESCRIPTION OF THE DRAWINGS

FIG. 1 is a perspective view of a cat scratching device in accordance with an embodiment of the present invention shown in an inclined position;

FIG. 2 is a cross sectional view along line 2-2 of the cat scratching device of FIG. 1 in an inclined position;

FIG. 2A is a cross sectional view of the cat scratching device of FIG. 1 in a flat position;

FIG. 3 is a cross sectional view along line 3-3 of FIG. 2;

FIG. 4 is a cross sectional detail view of a locking mechanism for a cat scratching device in accordance with an embodiment of the present invention in an inclined position;

FIG. 5 is a bottom plan view of the back of a cat scratching device in a flat position;

FIG. 6 is a cross sectional view of a locking mechanism of the cat scratching device in a flat position;

FIG. 7 is a cross sectional view of a hinge for a self-supporting means of the cat scratching device in a flat position;

FIG. 8 is a cross sectional view of an overlapping section of a self-supporting means of the cat scratching device in a flat position,

FIG. 9 illustrates an alternative embodiment of the invention; and

FIG. 10 is a cross section along the line 10-10 of FIG. 9.

### DETAILED DESCRIPTION OF THE INVENTION

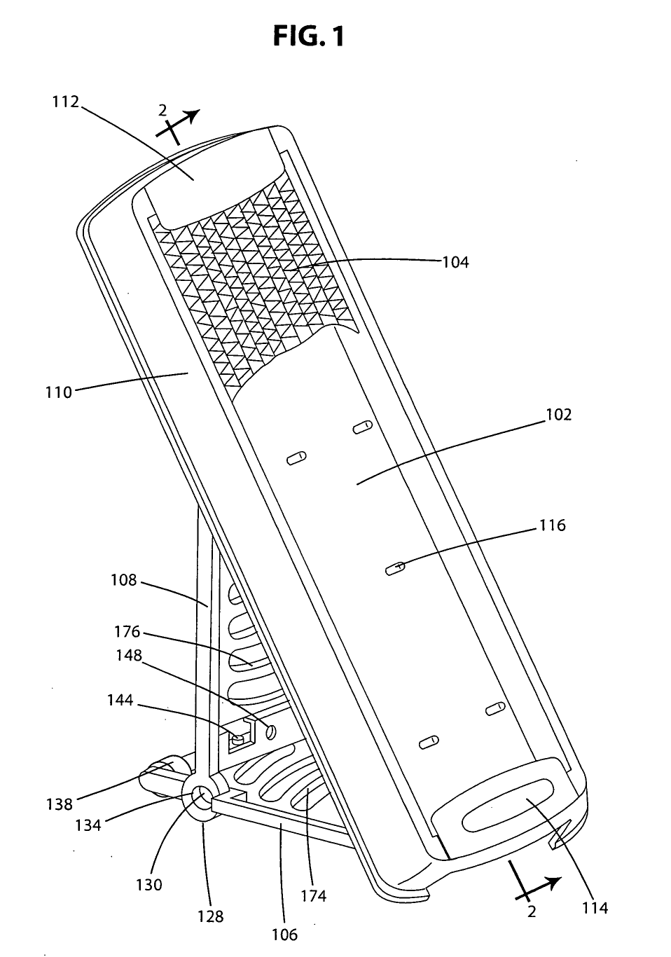

In the preferred embodiment, as shown in FIG. 1, the cat scratching device includes a base 102, scratch resistant material 104, and a pair of plate-like legs 106, 108 to support the cat scratching device. The base is configured into a rectangular shape with side walls 110, top flap 112 and bottom flap 114, and is composed of molded plastic. The scratch resistant material 104 is cut into a rectangular sheet that sits on the base 102. Small pins 116 extend from the front of the base 102 and secure the scratch resistant material 104. The cat scratching device is designed so as to allow the replacement of the scratch resistant material 104.

To replace the scratch resistant material 104, the top flap 112 rotates from the flat ‘closed position’ through approximately ninety degrees to the ‘open position.’ When in the closed position, the top flap 112 extends over the top of the scratch resistant material 104, holding it in place. By rotating the top flap 112 to the open position, the scratch resistant material 104 can be removed. The back of the top flap 112 articulates against the side walls 110 when switching from the open position to the closed position. In the closed position, the top flap 112 does not contact the side walls 110, thus the top flap 112 clicks into the closed position once the friction of the contact with the side walls 110 is removed.

The bottom flap 114 also secures the scratch resistant material 104. The bottom flap 114 can be removed, and is held in place by several flat plates 118 that protrude from the inside of the bottom flap 114 and are inserted into corresponding holes in the side wall of the base 110. It is not necessary to remove the bottom flap 114 in order to replace the scratch resistant material 104.

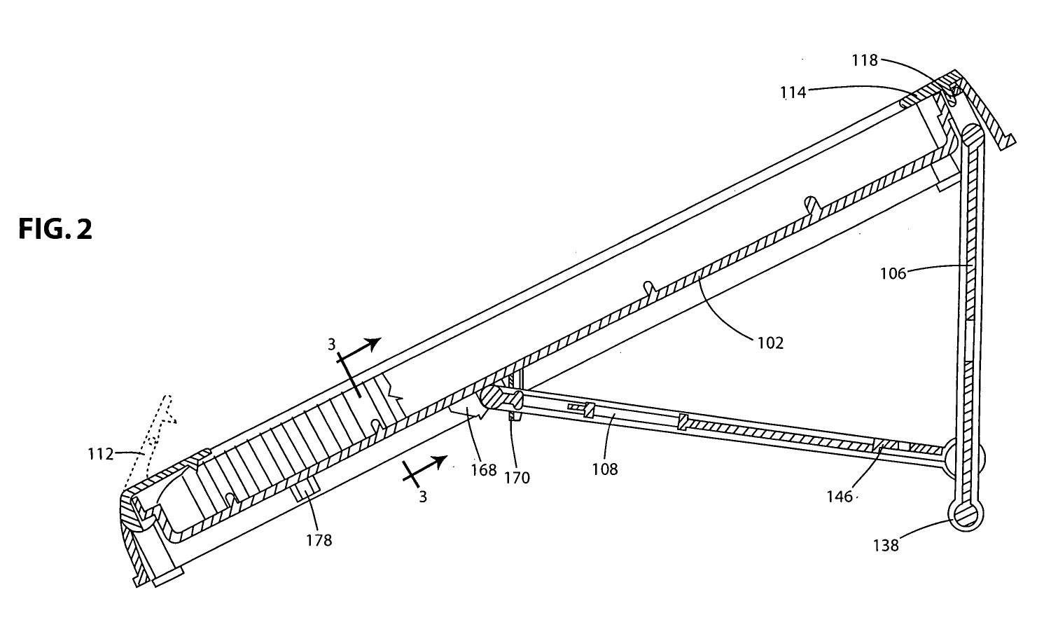

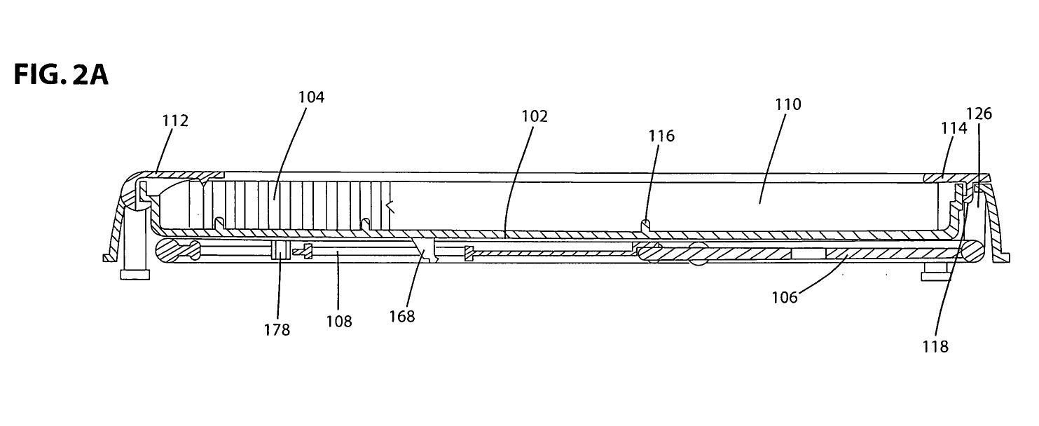

FIG. 2 illustrates base 102 supported by a first leg 106 and a second leg 108. The first leg 106 has a rounded bottom end that extends past its width on both sides. This rounded bottom end acts as an axle, where the portions that extend past the width of the first leg 106 act as pins 120, 122. The pins 120, 122 are inserted into holes in the walls 124, 126. This arrangement allows the first leg 106 to pivot where it is attached to the base 102.

The first leg 106 connects with the second leg 108 at a point 128 (see FIG. 1) near the rounded top end of the first leg 106. From the point of the connection 128 to the top end of the first leg 106, the sides of the plate-like first leg 106 narrow slightly. Pins 130, 132 (see FIG. 1) are located on either side of the top end of the first leg 106 where it has narrowed. These pins fit into circular holes 134, 136 on either side of the bottom end of the second leg 108. By articulation of the pins 130, 132 in the holes 134, 136, the bottom end of the second leg 108 can pivot through approximately ninety degrees.

At the top end of the first leg 106, there are two rubber cylinders 138, 140 which act to retard horizontal motion of the cat scratching device when in its inclined position. These two cylinders 138, 140 fit around opposing sides of the top of the first leg 106.

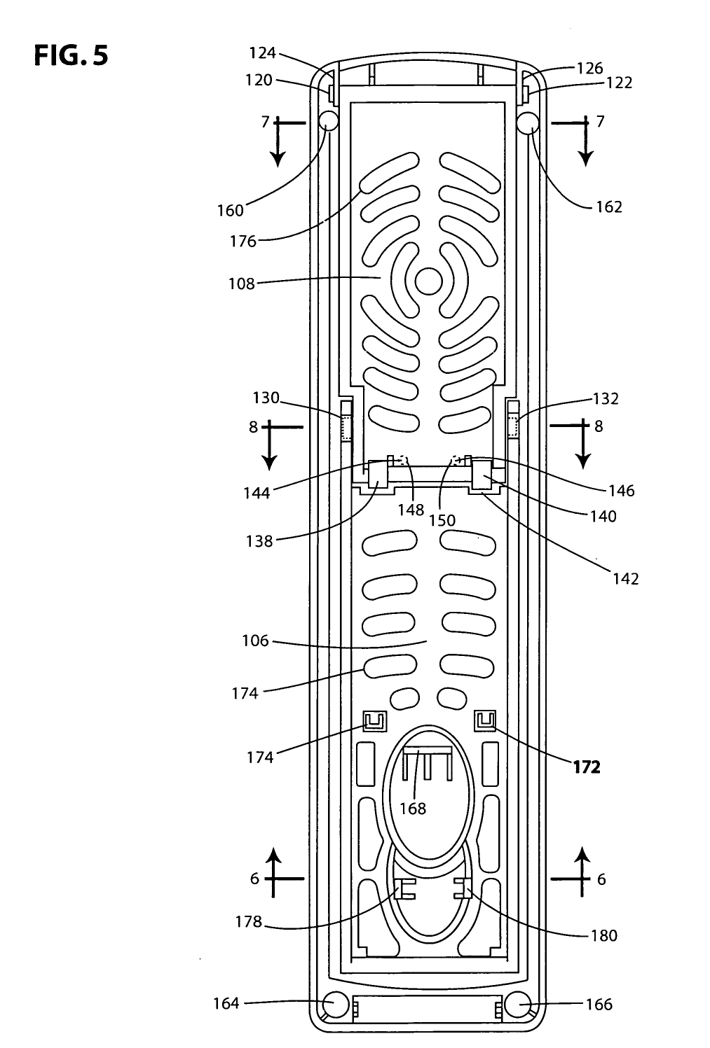

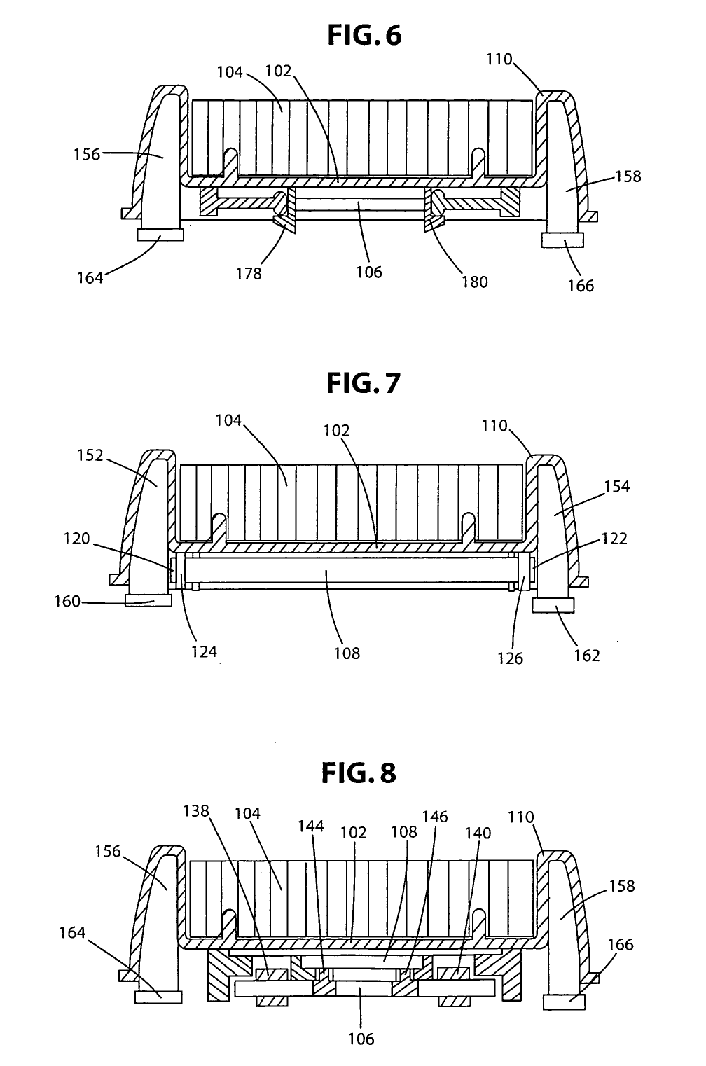

When the scratching device is in its flat position, as seen in FIG. 5, the legs 106, 108 are laid down on the back of the base 102. The top end of the first leg 106 overlaps the bottom end of the second leg 108. The bottom end of the second leg 108 has a recessed front face 142 that accepts the top end of the first leg 106. To aid in joining the top end of the first leg 106 to the bottom end of the second leg 108, there are two pins 144, 146 on the top end of the first leg 106. These pins 144, 146 fit in corresponding holes 148, 150 on the bottom end of the second leg 108.

Additionally, when in the flat position, the rubber cylinders 138, 140 fit into square holes cut out of the recessed front face 142 of the bottom end of the second leg 108. Thus, when in the flat position, the two legs 106, 108 and the cylinders 138, 140 lie flat against one another. This feature allows the cat scratching device in the flat position to be placed flat on a horizontal surface and sit evenly, without the legs 106, 108 or the cylinders 138, 140 protruding from the back of the base.

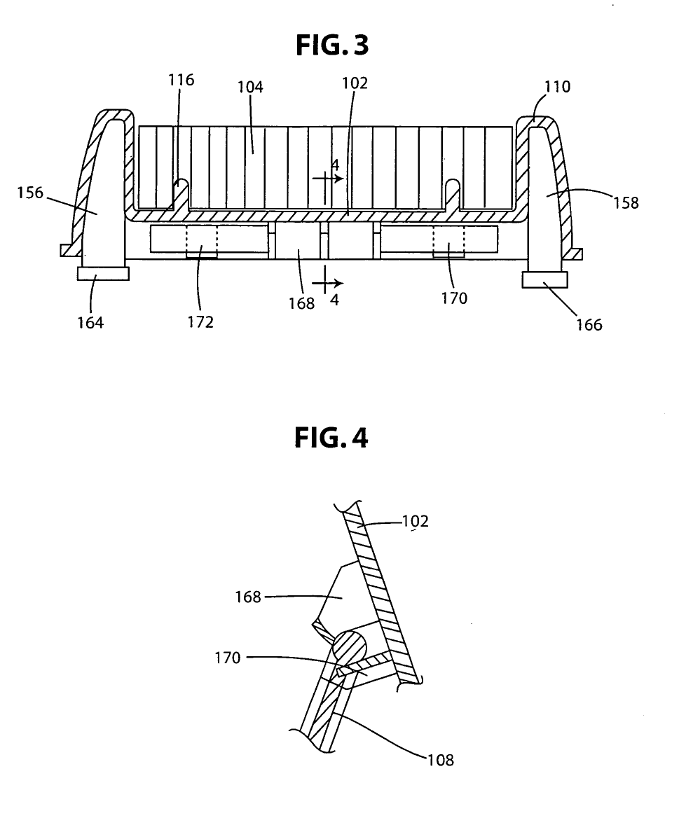

Four hollow, cylindrical supports 152, 154, 156, 158 hold up the base 102 when in the flat position. The supports 152, 154, 156, 158, which can be seen in FIG. 3, are located at each corner of the rectangular base 102. At the bottom of the supports 152, 154, 156, 158, are inserted feet 160, 162, 164, 166, which are circular and flat on their bottoms.

When the base 102 is supported in the inclined position, as seen in FIG. 2, the second leg 108 makes an approximately right angle with the first leg 106. The top end of the second leg 108 contacts the back of the base 102 approximately halfway between the top and bottom ends of the base 102. The rounded top end of the second leg 108 is secured to the base 102 between a top holder 168 and a pair of bottom holders 170, 172, as seen in FIG. 4. The top holder 168 is centrally located on the back of the base 102, and has a curved surface for holding the rounded top end of the second leg 108. The pair of bottom holders 170, 172 are located slightly below and to either side of the top holder 168. The second leg 108 is easily attached to and separated from the holders 168, 170, 172, providing for easy assembly and disassembly.

FIG. 5 illustrates the plate-like legs 106, 108 which have cut-out patterns 174, 176. The holes in the pattern of the second leg 108 provide locations for holding the leg 108 in place when laid flat against the back of the base 102. In the flat position, the second leg 108 is held in place by the pair of holders 178, 180, which are on the back of the base 102, near the top end.

The two legs 106, 108 for supporting the base 102 in an inclined position have been described for purposes of illustration only and not for purposes of limitation. The supporting structure for the scratching apparatus can alternatively be any structure known in the art that can expand to allow the base 102 to be positioned on an incline.

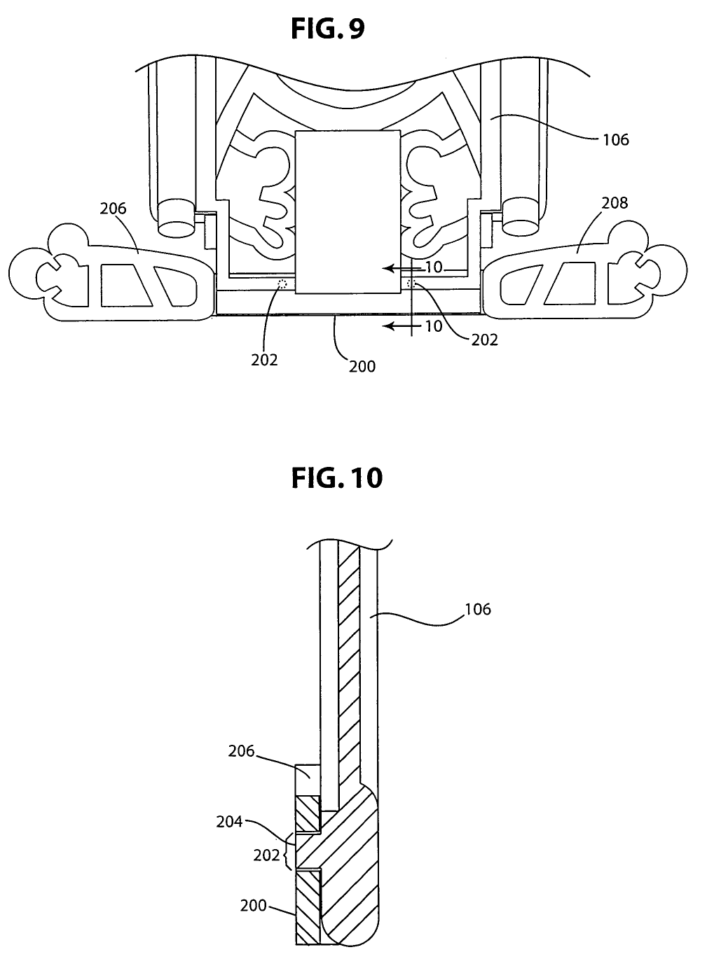

FIG. 9 shows a second embodiment of the invention in which a stabilizer 200 is attached to the bottom plate 106. The stabilizer includes two holes 202 in its center region which can engage a pair of pins 204 extending upwardly from the end of the leg 106 furthest from the scratching surface. The stabilizer 200 includes enlarged lateral extensions 206 and 208 which are adapted to engage the surface on which the device is mounted thereby stabilizing the device during use. As illustrated, the legs 106 and 108 and stabilizer 200 may be provided with decorative surfaces to enhance the visual appeal of the device. Preferably, the stabilizer is attached at the time of use by inserting pins 204 into holes 202, but the parts may also be permanently attached during manufacture.

Many variations of the present invention will suggest themselves to those skilled in the art in light of the above detailed description. All such obvious variations are within the fully intended scope of the application.

What is claimed as new and desired to be protected by Letters Patent of the United States is:

1. A scratching device comprising:
a base having a front and a back surface and a top and bottom end;
a scratch-resistant material secured to the front surface of the base;
a support that holds the base at an angle with respect to a horizontal surface;
wherein the support comprises two legs, each having a first and second end;
wherein the first leg is at its first end connected pivotally to the bottom end of the base and at its second end connected pivotally to the first end of the second leg, and wherein the second end of the second leg can be attached to the back surface of the base;
holding means on the back surface of the base for holding the second end of the second leg on the back surface of the base, wherein the second end of the second leg can be removed from the holding means to flatten the device; and
wherein the first and second legs lay flat on the back surface of the base when flattened.

2. A scratching device according to claim 1, wherein the base has two flaps, the first at the top end of the front surface of the base and the second at the bottom end of the front surface of the base;
wherein the first flap has a closed position in which the flap covers the top of the scratch resistant material, holding it in place, and
wherein the first flap has an open position in which the flap rotates through approximately ninety degrees in order to allow the replacement of the scratch resistant material.

3. A scratching device according to claim 1, further including stabilizer means connected to the end of the first leg remote from the scratch resistant material, said stabilizing means extending beyond the sides of said first leg and serving to stabilize the scratching device during use.
